(19) United States
(12) Patent Application Publication
(10) Pub. No.: US 2018/0149988 A1
(43) Pub. Date: May 31, 2018

(54) BASE MATERIAL FOR ELECTROPHOTOGRAPHY

(71) Applicant: GOJO PAPER MFG. CO., LTD., Fuji-shi, Shizuoka (JP)

(72) Inventors: Isokazu KAWAGUCHI, Fuji-shi, Shizuoka (JP); Koichiro KAWAGUCHI, Fuji-shi, Shizuoka (JP)

(73) Assignee: GOJO PAPER MFG. CO., LTD., Fuji-shi, Shizuoka (JP)

(21) Appl. No.: 15/506,679

(22) PCT Filed: May 17, 2016
(86) PCT No.: PCT/JP2016/064585

§ 371 Date: Feb. 24, 2017

(30) Foreign Application Priority Data
Jan. 28, 2016 (JP) 2016-014431

(51) Int. Cl. G03G 7/00; C09J 7/30; B32B 27/18; B32B 27/34

(52) U.S. Cl. CPC G03G 7/0013; G03G 7/0026; B32B 27/34; B32B 27/18; C09J 7/30

(57) ABSTRACT

A base material for electrophotography is produced by stacking a base paper, a water-based adhesive layer constituted by water-soluble or water-dispersible adhesive containing 3 to 5 g/m² of solids, a metal layer, and a polyamide resin layer, in this order. The base material that uses adhesive does not wrinkle when laminated, has sufficient metallic gloss through a metal deposition layer, ensures that electrophotographic printing is implemented in a reliable manner, and allows for easy separation/collection of each layer when the used sheets are collected and recycled.

### TECHNICAL FIELD

The present invention relates to a base material for electrophotography.

### BACKGROUND ART

The electrophotographic technique, traditionally adopted for copiers and PCs with print function, etc., now supports higher definition and colors and is thus utilized in recent years for proofing as part of offset printing and for on-demand printing of small number of copies.

In the meantime, sheets designed to achieve excellent aesthetics with the offset printing technique are available, which are constituted by paper laminated with a metallic-looking PET film having a vacuum-deposited aluminum surface.

The electrophotographic technique uses, e.g., a method whereby a photosensitive roll that has been charged with electricity by means of corona electrification using a scorotron, etc., or by using a charge roller, etc., is discharged using laser beams, etc., to form an electrostatic image, and toners picked up by this image are transferred onto a sheet of paper while the transferred toners are also heated by a fixing roll and fixed; and a method whereby toners on a photosensitive roll are transferred onto a transfer belt or transfer roll by electric potential force, and then transferred further onto a sheet of paper. Under any of the methods, however, the sheet of paper is charged with electricity by transferring toners with respect to electric potential.

In the above, normal coated paper or uncoated paper, even charged with electricity, discharges that electricity before the paper is ejected, resulting in lowering the possibility of sheets sticking together or to the machine and having difficulty in separation due to electrostatics when ejected. However, when sheets having a layer constituted by aluminum or other metal are used, oftentimes the PET layer present on top of the metal layer causes the charged sheets to stick together to create ejection problems. If an aluminum deposition surface constitutes the surface layer, toners cannot be transferred because this aluminum layer is a conductor. This is also the case when a toner-receiving layer is formed on top of the aluminum layer. Even when the toner-receiving layer contains antistatic agent or surface active agent, ejection problems cannot be always eliminated.

Also, Patent Literature 1 describes an example of providing a toner-receiving layer containing colloidal silica or cationic compound on the surface of a resin film; Patent Literature 2 describes a sheet of paper made by laminating paper with metal-deposited nylon to prevent cracking of ruled lines as they are drawn to construct a package and also to prevent the paper from warping; and Patent Literature 3 describes a packaging material that includes a paper base material layer and a polyamide resin-containing layer to offer excellent oxygen absorbency and oxygen barrier performance.

### BACKGROUND ART LITERATURE

### Patent Literature

Patent Literature 1: Japanese Patent Laid-open No. 2013-205611

Patent Literature 2: International Patent Laid-open No. 2015/092931

Patent Literature 3: International Patent Laid-open No. 2013/002079

### SUMMARY OF THE INVENTION

### Problems to Be Solved by the Invention

Even with the sheet of paper described in Patent Literature 1 above, sheet ejection problems may still occur when printing electrophotographs, and if the base paper is laminated with a resin film made by aluminum deposition, the substance contained in the toner-receiving layer impairs the transparency of the resin film and the brightness of the aluminum deposition layer drops when seen through the resin film.

In addition, the sheet of paper described in Patent Literature 2 is associated with poor productivity because the resin film on which metal is deposited is bonded to the base paper by means of dry lamination, and also because the adhesive used is not water-soluble, separating the resin film, metal, and base paper and collecting them discretely is difficult when the used sheets are recycled.

The packaging material described in Patent literature 3 is not intended to actively provide an aluminum layer between the paper base material layer and polyamide layer, to improve printability, or the like, and separating the polyamide and paper base material layers and collecting them discretely is difficult when the used sheets are recycled.

Accordingly, an object of the present invention is to obtain a base material for electrophotography that uses water-based adhesive, does not wrinkle when laminated, has sufficient metallic gloss through a metal deposition layer, ensures that electrophotographic printing is implemented in a reliable manner, and in addition, allows for easy separation/collection of each layer when the used sheets are collected and recycled.

### Means for Solving the Problems

The present invention, which is designed to achieve the aforementioned object, is described as follows:
1. Base material for electrophotography produced by stacking a base paper, a water-based adhesive layer constituted by a water-soluble or water-dispersible adhesive containing 3 to 5 g/m² of solids, a metal layer, and a polyamide resin layer, in this order.
2. Base material for electrophotography according to 1, wherein the metal layer is a deposition layer on the polyamide resin layer.
3. Base material for electrophotography according to 1 or 2, wherein the metal layer is an aluminum layer.
4. Base material for electrophotography according to any one of 1 to 3, wherein the polyamide resin layer is a layer constituted by nylon 6.
5. Base material for electrophotography according to any one of 1 to 4, wherein the base paper is uncoated paper, art paper, coated paper, or cast coated paper.
6. Method of manufacturing a base material for electrophotography, comprising: providing a metal layer on one side of a polyamide resin film; and bonding the surface of the metal layer with the surface of a base paper using a water-based adhesive constituted by water-soluble or water-dispersible adhesive.
7. Method of manufacturing a base material for electrophotography according to 6, wherein the water-based adhesive has a solid concentration of 45 to 60 percent by weight and a viscosity of 500 to 4,000 mPa·s, and also the water-based adhesive is used to a solid content of 3 to 5 g/m².
8. Electrophotography paper produced by further providing a toner-receiving layer on the surface of the polyamide resin layer in the base material for electrophotography according to any one of 1 to 5.
9. Method of treating a paper-based material having an aluminum layer, whereby the paper-based material having a metal layer is treated with alkaline aqueous solution, to collect the aluminum as aluminate ions, and the paper as recycled pulp.

### Effects of the Invention

According to the present invention, a base material for electrophotography can be achieved that does not wrinkle during manufacturing, where such base material also adds metallic gloss to prints, and because no strong static electricity generates during printing, electrophotographic printing can be implemented smoothly until ejection.

Additionally, when this base material for electrophotography is used, the base paper can be separated from the aluminum layer and polyamide layer in an easy, reliable manner to be recycled as base material for pulp, etc.

### MODE FOR CARRYING OUT THE INVENTION

The base material for electrophotography proposed by the present invention is basically produced by stacking a base paper, a water-based adhesive layer constituted by water-soluble or water-dispersible adhesive containing 3 to 5 g/m² of solids, a metal layer, and a polyamide resin layer, in this order, and a toner-receiving layer can be formed optionally on top of the polyamide resin layer.

Also, while the layers can be stacked as above on one side of the base paper, they can be stacked in the same manner on both sides of the base paper to permit electrophotographic recording on both sides.

The specific constitution of each layer is described below.

### Polyamide Resin Layer

For use as the polyamide resin layer under the present invention, any known polyamide resin can be selected.

Since this layer is used as the uppermost layer or the layer below the toner-receiving layer to constitute the base material for electrophotography, it can contain a certain quantity of water to provide antistatic property. For this reason, a polyamide resin layer is adopted under the present invention, because it is not charged with electricity excessively during printing and can demonstrate specified strength.

It should be noted that, to form an aluminum layer, a polyamide resin film or sheet is used and its thickness is 5 to 30 μm or preferably 10 to 20 μm. If the thickness is less than 5 μm, handling difficulty may be encountered or sufficient antistatic property required of any base material for electrophotography may not be demonstrated. If the thickness exceeds 30 μm, on the other hand, rigidity may become too high for a base material for electrophotography.

Such polyamide resin may be, e.g., a polyamide resin synthesized from polyamine such as diamine or trivalent or higher-valent polyamine on one hand, and polycarboxylic acid such as dicarboxylic acid or trivalent to hexavalent or higher-valent polycarboxylic acid or other polycarboxylic acid on the other. Among these, a polyamide resin synthesized from diamine and dicarboxylic acid is preferred.

To be specific, any of the following polyamide resins can be used: Aliphatic polyamide resin (nylon 6, nylon 11, nylon 12, nylon 46, nylon 66, nylon 610, nylon 612, etc.); polyamide resin whose diamine component at least is an aliphatic compound (nylon 6T, nylon 6T copolymer, nylon 9T, etc.); or semiaromatic (copolymer) polyamide resin (nylon MXD6, nylon 6T/6, nylon 6T/66, nylon 6T/12, nylon 6I/6, nylon 6I/66, nylon 6T/6I, nylon 6T/6I/6, nylon 6T/6I/66, nylon 6T/MST, etc.).

Antistatic agent, pigment, dye or any other known additive may be blended into the polyamide resin layer.

### Metal Layer

Under the present invention, the metal layer is formed on one side of the polyamide resin layer.

The metal layer can be formed on one side of a layer constituted by polyamide resin film or sheet, using the deposition method, sputtering method, CVD method, ion plating method, or any other known means.

The purpose of this metal layer is to add metallic gloss to the base material for electrophotography proposed by the present invention, and although aluminum, silver, copper, gold, zinc, iron, nickel, platinum, or any other metal can be adopted as desired, preferably aluminum is used for this metal in consideration of ease of handling, etc.

Also, the thickness of the metal layer, while varying depending on how it is formed, can be anywhere between approx. 20 nm to 10 μm so long as the thickness provides sufficient flexibility for the base material for electrophotography to pass through the machine smoothly during printing, as well as sufficient metallic gloss required of any base material for electrophotography.

### Base Paper

Base papers that can be used under the present invention are not limited in any way, and any generally used paper may be used; however, smooth base papers, such as those used for electrophotography, are more preferable. For the pulp constituting the base paper, LBKP (leaf bleached kraft pulp), NBKP (northern bleached kraft pulp) or other chemical pulp, GP (ground pulp), PGW (pressurized ground wood pulp), RMP (refiner mechanical pulp), TMP (thermo mechanical pulp), CTMP (chemical thermo mechanical pulp), CMP (chemical mechanical pulp), CGP (chemical ground pulp) or other mechanical pulp, or other natural pulp, or recycled pulp, synthetic pulp, etc. can be used alone or two or more types of the foregoing may be mixed together and used. Any internal sizing agent, paper strengthening agent, filler, antistatic agent, fluorescent whitening agent, dye, or any additive generally used for papermaking may be blended into this base paper.

Furthermore, surface sizing agent, surface paper strengthening agent, fluorescent whitening agent, antistatic agent, dye, anchor agent, etc., may be applied on one side or both sides. Among the papers on which these agents are applied, preferably coated paper or cast coated paper is used.

Also, while the thickness of the base paper is not limited in any way, preferably the paper is pressurized by calendering, etc., and thus compressed during or after production to achieve good surface smoothness, and preferably the grammage of the base paper is 40 to 400 g/m².

It should be noted that, preferably the Taber hardness (JIS 8125: 2000) of the base paper alone is 0.1 mN·m or more. More preferably, it is 0.5 mN·m or more. Under the present invention, the Taber hardness of the base paper alone may be low, considering that the base material for electrophotography also has a metal layer and a polyamide resin layer.

### Water-Based Adhesive Layer Constituted by Water-Soluble or Water-Dispersible Adhesive

Under the present invention, the water-based adhesive layer constituted by water-soluble or water-dispersible adhesive must have a property that quickly dissolves or disperses in an alkaline aqueous solution when the used base material for electrophotography is treated in an alkaline aqueous solution.

Because the adhesive has this property, the base material and the polyamide resin film with metal layer can be separated from the used base material of electrophotography. As a result, the base paper can be reused as recycled pulp, and the polyamide resin film with metal layer can also be reused as metal and polyamide resin after treatment using different chemicals, etc.

For this reason, water-soluble adhesives that can be used under the present invention include, for example, oxidized starch, etherified starch, phosphate-etherified starch or other starch derivative; carboxy methyl cellulose, hydroxy ethyl cellulose or other cellulose derivative; casein, gelatin or other natural high-polymer water-soluble adhesive; or synthetic high-polymer water-soluble adhesive using ethylene-vinyl acetate copolymer resin, polyvinyl alcohol (PVA) resin, polyethylene oxide resin, polyvinyl amide resin, polyvinyl pyrrolidone resin, polyvinyl acetal resin, polyacrylate resin, acrylic resin, polyester resin, resol resin, urea resin, melamine resin, etc.

Among these, preferably water-soluble acrylic resin adhesive agent or polyvinyl alcohol (PVA) resin adhesive is used.

Also, water-dispersible adhesives include latex adhesives and emulsion adhesives using polyacrylate, polyacrylate ester, polybutyl methacrylate or other acrylic resin; polyvinyl acetate, vinyl chloride-vinyl acetate copolymer, ethylene-vinyl acetate copolymer or other polyolefin resin; styrene-butadiene copolymer, styrene-butadiene-acrylonitrile copolymer, acrylonitrile-butadiene copolymer, styrene-isoprene copolymer or other diene copolymer; polyurethane, silylated urethane or other urethane resin; acryl-silicone complex, acryl-silicone-urethane complex, ionomer urethane resin latex, (meth)acrylic amide copolymer having core-shell structure, etc. Among these, a water-dispersible adhesive using ethylene-vinyl acetate copolymer or other polyolefin resin, acrylic resin, or (meth)acrylic amide copolymer having core-shell structure, etc., is preferred.

### How to Bond Base Paper and Metal Layer Surface

To obtain the base material for electrophotography proposed by the present invention, at least one side of the base paper must be bonded with the polyamide resin layer on which the metal layer has been formed, on the surface on this metal layer side, via the aforementioned water-based adhesive layer constituted by water-soluble or water-dispersible adhesive.

Accordingly, it is necessary to apply the water-based adhesive constituted by water-soluble or water-dispersible adhesive on the surface of the base paper and/or surface of the metal layer by any known means, and then pressure-bond the surface of the base paper with the surface of the metal layer, followed by heating, if necessary. For the specific bonding conditions, or specifically the amount of adhesive used, pressurization force, pressurization time, temperature, etc., any known conditions for bonding paper using water-based adhesive constituted by water-soluble or water-dispersible adhesive may be used.

For example, the amount of adhesive used may be 3.0 to 5.0 g/m² in solid content.

### Surface Treatment of Polyamide Resin Layer

On the base material for electrophotography proposed by the present invention, a toner-receiving layer can be formed on the surface of the polyamide resin layer, for receiving toners.

For the toner-receiving layer, any known toner-receiving layer can be applied. For the resin from which to form the toner-receiving layer, any resin that achieves good toner transferability from the electrophotographic photosensitive body or intermediate transfer body, as well as good toner receptivity, is used. For such toner-receiving layer resin, polyester resin, polystyrene resin, styrene-acrylic resin, polyethylene imine resin, polyolefin resin, polycarbonate resin, vinyl chloride resin, vinylidene chloride resin, polyvinyl acetal resin, cellulose acetate butylate or other cellulose derivative resin, acrylic resin, ionomer resin, etc., can be used.

Also, to prevent the toner-receiving layer from fusing due to heating by the fixing roll when an image is formed, preferably one or more types of cross-linking agent, lubricant, die-release agent, etc., is/are added to the resin. If necessary, one or more types of fluorescent dye, plasticizer, antioxidant, UV absorbent, pigment, etc., can also be added to the toner-receiving layer, but no antistatic agent should be added. These additives may be mixed with the forming components of the toner-receiving layers and coated, or they may be coated above and/or below the toner-receiving layer as a cover layer separate from the toner-receiving layer.

The coating amount of toner-receiving layer in solid content is preferably approx. 0.1 to 30 g/m², or more preferably 0.3 to 20 g/m². If the coating amount of toner- receiving layer is less than 0.1 g/m², the toner-receiving layer cannot completely cover the surface of the support body, which potentially causes the image quality to drop or fusing trouble to occur that involves adhesion of the fixing roll and toner-receiving layer due to heating at the time of fixing. If the coating amount exceeds 30 g/m², on the other hand, the effect reaches a plateau and not only does the cost increase, but the coating film of the toner-receiving layer also fails to achieve sufficient strength, and because the thickness of the toner-receiving layer increases, the recording matter tends to bend and generate hair-cracks significantly, and consequently the image quality drops, which is not preferred.

In forming the toner-receiving layer on the surface of the polyamide resin layer, an intermediate layer can be provided on the surface of the polyamide resin layer beforehand. The intermediate layer has certain properties, including the ability to improve the adhesion between the polyamide resin layer and toner-receiving layer. For such intermediate layer, any thermoplastic resin layer or barrier layer can be adopted; however, the intermediate layer must be a layer that does not impair the water absorbency of the polyamide resin layer.

### EXAMPLES

### Example 1

On a base paper being a cast coated paper of 800 mm in width and 315 g/m² in grammage (Gojo Paper Mfg/Gloria Coat), a film constituted by nylon film (Unitika/Emblem, 15 μm) with aluminum vacuum-deposited thereon was laminated with a wet laminator, using an ethylene-vinyl acetate copolymer resin (53% in concentration, 500 mPa·s in viscosity, DB314, Saiden Chemical Industry) as adhesive, by an application amount of 3 g/m² in solid content, in such a way that the aluminum deposition surface of the nylon film would face the coated surface of the cast coated paper, after which a Hewlett-Packard (HP) Indigo primer (Maruyoshi Michelman/Digi-Prime) was applied on the nylon film with a gravure coater to a solid content of 0.5 g/m² for the purpose of improving the printability, and dried, to obtain a film-laminated paper. The laminator speed was 100 m/min, and the drying temperature was 90° C. This paper was printed with five colors (white, black, cyan, magenta, yellow) using the HP Indigo 10000 digital printer.

### Example 2

On a base paper being a coated paper of 800 mm in width and 310 g/m² in grammage (Nippon Paper Industries/JET Ace), a film constituted by nylon film (Unitika/Emblem, 15 μm) with aluminum vacuum-deposited thereon was laminated with a wet laminator, using an acrylic copolymer resin (47% in concentration, 1250 mPa·s in viscosity, PZ905, Saiden Chemical Industry) as adhesive, by an application amount of 4 g/m² in solid content, in such a way that the aluminum deposition surface of the nylon film would face the coated surface of the coated paper, after which a polyester primer (Toyo Ink Mfg/PET134 Anchor) was applied on the nylon film with a gravure coater to a solid content of 1 g/m² for the purpose of improving the printability, and dried, to obtain a film-laminated paper. This paper was printed with four colors (black, cyan, magenta, yellow) using the Fuji Xerox Versant digital printer.

### Comparative Example 1

On a base paper being a cast coated paper of 800 mm in width and 315 g/m² in grammage (Gojo Paper Mfg/Gloria Coat), a PET film (Toray Advanced Film/VM-PET1510, 12 μm) with aluminum vacuum-deposited thereon was laminated with a wet laminator, using an ethylene-vinyl acetate copolymer resin (53% in concentration, 500 mPa·s in viscosity, DB314, Saiden Chemical Industry) as adhesive, by an application amount of 3 g/m² in solid content, in such a way that the aluminum deposition surface of the PET film would face the coated surface of the cast coated paper, after which the same primer layer as in Example 1 was provided on the surface of the PET film for the purpose of improving the printability. This paper was printed with five colors (white, black, cyan, magenta, yellow) using the HP Indigo 10000 digital printer; however, strong static electricity generated in the paper ejection area and the sheets did not align.

### Comparative Example 2

The paper in Comparative Example 1 was printed with four colors (black, cyan, magenta, yellow) using the Fuji Xerox Versant digital printer; however, strong static electricity generated in the paper ejection area and the sheets did not align.

### Comparative Example 3

On a base paper being a cast coated paper of 800 mm in width and 279 g/m² in grammage (Gojo Paper Mfg/Gloria Coat), a PET film (Toray Advanced Film/VM-PET1510, 12 μm) with aluminum vacuum-deposited thereon was laminated with a wet laminator, using an ethylene-vinyl acetate copolymer resin (53% in concentration, 500 mPa·s in viscosity, DB314, Saiden Chemical Industry) as adhesive, by an application amount of 3 g/m² in solid content, in such a way that the film surface would face the coated surface of the cast coated paper, after which the same primer layer as in Example 1 was provided on the aluminum deposition surface of the PET film for the purpose of improving the printability. This paper was printed with five colors (white, black, cyan, magenta, yellow) using the HP Indigo 10000 digital printer; however, not only did the toner ink fail to transfer properly, but the machine also stopped after several sheets.

### Comparative Example 4

On a base paper being a cast coated paper of 800 mm in width and 279 g/m² in grammage (Gojo Paper Mfg/Gloria Coat), a PET film (Toray Advanced Film/VM-PET1510, 12 μm) with aluminum vacuum-deposited thereon was laminated with a wet laminator, using an ethylene-vinyl acetate copolymer resin (53% in concentration, 500 mPa·s in viscosity, DB314, Saiden Chemical Industry) as adhesive, by an application amount of 4 g/m² in solid content, in such a way that the aluminum deposition surface of the PET film would face the coated surface of the cast coated paper, after which the same Hewlett-Packard Indigo primer (Maruyoshi Michelman/Digi-Prime) used in Example 1, to which an antistatic agent (Marubishi Oil Chemical/PC3562) had been added by 1 percent by weight, was applied on the surface of the PET film with a gravure coater to a solid content of 0.5 g/m² for the purpose of improving the printability, and dried, to obtain a film-laminated paper. This paper was printed with five colors (white, black, cyan, magenta, yellow) using the HP Indigo 10000 digital printer; however, the toner ink did not transfer properly, and the sheets did not align sufficiently, either.

### Comparative Example 5

On a base paper being a coated paper of 800 mm in width and 310 g/m² in grammage (Nippon Paper Industries/JET Ace), a film constituted by nylon film (Unitika/Emblem, 15 μm) with aluminum vacuum-deposited thereon was laminated with a wet laminator, using an acrylic copolymer resin (47% in concentration, 1250 mPa·s in viscosity, PZ905, Saiden Chemical Industry) as adhesive, by an application amount of 7 g/m² in solid content, in such a way that the aluminum deposition surface of the nylon film would face the coated surface of the coated paper, after which the same Hewlett-Packard Indigo primer (Maruyoshi Michelman/Digi-Prime) used in Example 1 was applied on the surface of the nylon film with a gravure coater to a solid content of 0.5 g/m² for the purpose of improving the printability, and dried; however, an excessive solid content in the adhesive layer caused the paper to wrinkle in the drying oven.

### Comparative Example 6

On a base paper being a coated paper of 800 mm in width and 310 g/m² in grammage (Nippon Paper Industries/JET Ace), a film constituted by nylon film (Unitika/Emblem, 15 μm) with aluminum vacuum-deposited thereon was laminated with a wet laminator, using an acrylic copolymer resin (47% in concentration, 1250 mPa·s in viscosity, PZ905, Saiden Chemical Industry) as adhesive, by an application amount of 2 g/m² in solid content, in such a way that the aluminum deposition surface of the nylon film would face the coated surface of the coated paper, after which the same Hewlett-Packard Indigo primer (Maruyoshi Michelman/Digi-Prime) used in Example 1 was applied on the surface of the nylon film with a gravure coater to a solid content of 0.5 g/m² for the purpose of improving the printability, and dried; however, insufficiently bonded areas were created where the paper surface concaved.

Also, adhesive did not achieve sufficient coverage because the application amount of adhesive was less than 3 g/m² in solid content.

The printing paper obtained in Example 1 was cut to thin strips of 2 cm×10 cm, from which 10 g was weighed and taken, and then soaked in 1 L of water containing caustic soda by 0.5 percent by weight and mixed in a mixer to obtain a slurry. This slurry was filtered through a wire net of 5.6 mm in opening (3.5 mesh), and the obtained slurry was used to create a handmade sheet.

1. Base material for electrophotography produced by stacking a base paper, a water-based adhesive layer constituted by water-soluble or water-dispersible adhesive containing 3 to 5 g/m² of solids, a metal layer, and a polyamide resin layer, in this order.

2. Base material for electrophotography according to claim 1, wherein the metal layer is a deposition layer on the polyamide resin layer.

3. Base material for electrophotography according to claim 1, wherein the metal layer is an aluminum layer.

4. Base material for electrophotography according to claim 1, wherein the polyamide resin layer is a layer constituted by nylon 6.

5. Base material for electrophotography according to claim 1, wherein the base paper is uncoated paper, art paper, coated paper or cast coated paper.

6. Method of manufacturing a base material for electrophotography, comprising:
providing a metal layer on one side of a polyamide resin film; and
bonding a surface of the metal layer with a surface of a base paper using a water-based adhesive constituted by water-soluble or water-dispersible adhesive.

7. Method of manufacturing a base material for electrophotography according to claim 6, wherein the water-based adhesive has a solid concentration of 45 to 60 percent by weight and a viscosity of 500 to 4,000 mPa·s, and also the water-based adhesive is used to a solid content of 3 to 5 g/m².

8. Electrophotographic paper produced by further providing a toner-receiving layer on a surface of the polyamide resin layer in the base material for electrophotography according to claim 1.

9. Method of treating a paper-based material having an aluminum layer, whereby the paper-based material having a metal layer is treated with an alkaline aqueous solution, to collect the aluminum as aluminate ions and the paper as recycled pulp.

10. Base material for electrophotography according to claim 2, wherein the metal layer is an aluminum layer.

11. Base material for electrophotography according to claim 2, wherein the polyamide resin layer is a layer constituted by nylon 6.

12. Base material for electrophotography according to claim 2, wherein the base paper is uncoated paper, art paper, coated paper or cast coated paper.

13. Electrophotographic paper produced by further providing a toner-receiving layer on a surface of the polyamide resin layer in the base material for electrophotography according to claim 2.

14. Base material for electrophotography according to claim 3, wherein the polyamide resin layer is a layer constituted by nylon 6.

15. Base material for electrophotography according to claim 3, wherein the base paper is uncoated paper, art paper, coated paper or cast coated paper.

16. Electrophotographic paper produced by further providing a toner-receiving layer on a surface of the polyamide resin layer in the base material for electrophotography according to claim 3.

17. Base material for electrophotography according to claim 4, wherein the base paper is uncoated paper, art paper, coated paper or cast coated paper.

18. Electrophotographic paper produced by further providing a toner-receiving layer on a surface of the polyamide resin layer in the base material for electrophotography according to claim 4.

19. Electrophotographic paper produced by further providing a toner-receiving layer on a surface of the polyamide resin layer in the base material for electrophotography according to claim 5.
